(19) United States
(12) Patent Application Publication
(10) Pub. No.: US 2026/0024023 A1
(43) Pub. Date: Jan. 22, 2026

(54) SYSTEM AND METHOD OF MACHINE LEARNING SPECIALIZATION AND PRIORITIZATION FOR EXECUTION WITH SOFTWARE APPLICATIONS ON AN INFORMATION HANDLING SYSTEM

(71) Applicant: Dell Products LP, Round Rock, TX (US)

(72) Inventors: Jacob Mink, Cedar Park, TX (US); Srikanth Kondapi, Austin, TX (US)

(73) Assignee: Dell Products LP, Round Rock, TX (US)

(21) Appl. No.: 18/777,883

(22) Filed: Jul. 19, 2024

(51) Int. Cl. G06N 20/20

(52) U.S. Cl. CPC G06N 20/20

(57) ABSTRACT

A system and method of prioritizing invoking machine learning (ML) model algorithms during execution of a first AI productivity tool-enablable software applications on an information handling system includes a hardware processor executing code instructions to receive registerable capabilities from the first AI productivity tool-enablable software application, executing program code instructions to initiate a request for an ML model algorithm and to instantiate the ML model algorithm to receive input from the first AI productivity tool-enablable software application to execute a capability, and executing code instructions to determine priority of execution of the ML model algorithm with the first AI productivity tool-enablable software application relative to execution of a second ML model algorithm with a second AI productivity tool-enablable software application based on an ML model execution system policy and received telemetry data relating to execution of the ML model algorithm by the first AI productivity tool-enablable software application.

### FIELD OF THE DISCLOSURE

The present disclosure generally relates to execution of machine-readable code instructions of artificial intelligence (AI) productivity tools on an information handling system. The present disclosure more specifically relates systems and methods of runtime prioritizing and specializing operation of machine learning (ML) model algorithms invoked by AI productivity tool-enablable software applications.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications for word processing, communications, firmware business operations, gaming applications, or the like. Further, the information handling system may include machine readable code instructions for one or more AI productivity tools that interface with various AI productivity tool-enablable software applications that increase the efficiency of the operation of the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes an AI productivity tool module and an AI productivity tool subagent to select among and prioritize calls invoking one or more machine learning (ML) model algorithms by a plurality of AI productivity tool-enablable software applications according to an embodiment of the present disclosure;

FIG. 2 is a graphic and block diagram illustrating an information handling system that includes an AI productivity tool module and an AI productivity tool subagent to select among and prioritize calls invoking one or more ML model algorithms from a plurality of AI productivity tool-enablable software applications according to another embodiment of the present disclosure; and

FIG. 3 is a flow diagram showing a method of prioritizing invoking machine learning models during execution of artificial intelligence (AI) productivity tool-enablable applications on an information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase efficiency of computing systems. AI such as various machine learning (ML) models may be implemented on an information handling system with execution of machine model code instructions of one or more AI productivity tool modules executing with one or more AI productivity tool-enablable applications according to embodiments herein. In some examples, user-specific information may be gathered for a user or particular execution of AI productivity tool-enablable software applications and later injected into the ML model algorithms as input to better facilitate the operation of the ML model algorithm with an AI productivity tool-enablable software application invoking that ML model algorithm. Having this application information received from the AI productivity tool-enablable software applications with capabilities ahead of time allows it to be included with a request for invoking an ML model algorithm to facilitate execution of the ML model algorithm without requiring a request for this application data during execution which may delay execution. For example, relevant warranty information for a user or other user specific aspect may be relevant to execution of a capability for an AI productivity tool-enablable software application. Further, use-specific information, such as designation of user-facing application types versus background application types, may be gathered for a user or particular execution of AI productivity tool-enablable software applications and later injected into the ML model algorithms as input to better facilitate the operation of the ML model with an AI productivity tool-enablable software application invoking that ML model algorithm for determination of priority according to embodiments herein.

Not all such specialized data related to, for example, the execution of capabilities of the AI productivity tool-enablable software application invoking any ML model algorithm always available and provided during the invocation of the ML model algorithm. Indeed, telemetry data is collected by the information handling system as the AI productivity tool-enablable software application has been invoked and is using the ML model algorithm and stored. This telemetry data relating to execution of the ML model algorithm with the AI productivity tool-enablable software application may be used to affect the operations and quality of service (QOS) of operations of the information handling system according to embodiments herein and therefore be used in determination of prioritization of execution among plural ML model algorithms that may be executing with AI productivity tool-enablable software applications on an information handling system.

The present specification describes a method of prioritizing machine learning models invoked by the execution of artificial intelligence (AI) productivity tool-enablable applications. This method includes executing computer-readable program code instructions of a software development kit module with a hardware processor of an information handling system to initiate a request, on behalf of an AI productivity tool-enablable software application being executed on the information handling system, to an AI productivity tool subagent for executing computer-readable program code instructions of a machine learning (ML) model. The method further includes executing computer-readable program code instructions of an application capabilities and telemetry gathering module to receive registerable capabilities and application information from the AI productivity tool-enablable software application. Additionally, the method includes executing computer-readable program code instructions of an AI productivity tool subagent to receive a request from the AI productivity tool-enablable software application to instantiate the ML model algorithm to receive input from the AI productivity tool-enablable software application to the ML model algorithm. The method also includes executing computer-readable program code instructions of the application capabilities and telemetry gathering module to prioritize executing a first ML model algorithm of a first AI productivity tool-enablable software application relative to a second ML model algorithm of a second AI productivity tool-enablable software application. Prioritization may be made including a priority designation saved, such as in metadata or a data instruction, for a particular ML model algorithm or for a capability of an AI productivity tool-enablable software application that may execute such a prioritized ML model algorithm. In other embodiments, a priority queue or priority list of prioritized ML model algorithms and associated AI productivity tool-enablable software application may be stored by the AI productivity tool subagent for determining order of calls for ML model algorithm executions from plural AI productivity tool-enablable software application.

In an embodiment, the method may also include executing computer-readable program code instructions of a software development kit (SDK) module to transmit the registerable capabilities and application information to the AI productivity tool subagent via a remote process communication (RPC). The SDK may be responsible for initiating the request for the ML model algorithm when, for example, a user initiates a request at a graphical user interface (GUI) of an AI productivity tool-enablable software application for AI-based interfacing. These AI productivity tool-enablable software applications may include word processing applications, electronic mail applications, spreadsheet applications and the like that allow a user to be assisted, via AI, with composing documents or other actions. Still further, these AI productivity tool-enablable software applications may include applications that include, for example, system tool applications, system diagnostic applications, peripheral and monitor management applications, among other monitoring applications that facilitate the operation and management of the information handling system.

In an embodiment, the method includes executing computer-readable program code instructions of an ML model invocation effect monitoring module to monitor the effect of executing the ML model algorithm invoked by an AI productivity tool-enablable software application on the information handling system and store the effects executing the ML model algorithm invoked by the AI productivity tool-enablable software application on a data storage device. The effects of the ML model algorithm invoked by the AI productivity tool-enablable software application includes a data describing a frequency of use of the ML model algorithm, data describing hardware processor resource consumption via invocation of the ML model algorithm, data describing data storage consumption via invocation of the ML model algorithm, data describing data size of inputs to the ML model algorithm, and data describing data size of outputs from the ML model algorithm. In an embodiment, the registerable capabilities and application information from the AI productivity tool-enablable software application include user's usage data associated with a frequency of use of the AI productivity tool-enablable software application and tracking up-time or ongoing execution of the AI productivity tool-enablable software application. This data is used to prioritize execution of the ML model invoked by the AI productivity tool-enablable software application with other AI productivity tool-enablable software applications invoking their respective ML model algorithms such that productivity is increased at the information handling system while, for example, hardware processing resources are conserved for prioritized processes at the information handling system. As such, in one example embodiment, the method may be used to throttle any ML model algorithm executed for an AI productivity tool-enablable software application if the AI productivity tool-enablable software application uses an ML model too often relative to the impact on the information handling system. Priority determination for invoking or calling to invoke a priority order of ML model algorithms for AI productivity tool-enablable software applications may be according to an ML algorithm execution system policy set forth by an internet technology decision maker (ITDM). In other embodiments, frequently or continuously used ML model algorithms invoked by an AI productivity tool-enablable software application may receive higher priority due to a determined importance of use according to a different ML algorithm execution system policy set by an ITDM. In yet other embodiments, the prioritization of invoking the ML model for particular AI productivity tool-enablable software applications may be based on execution of the AI productivity tool-enablable software application in user-mode for a software providing a service via a user interface directly impacting or seen by a user over those that may operate in the background.

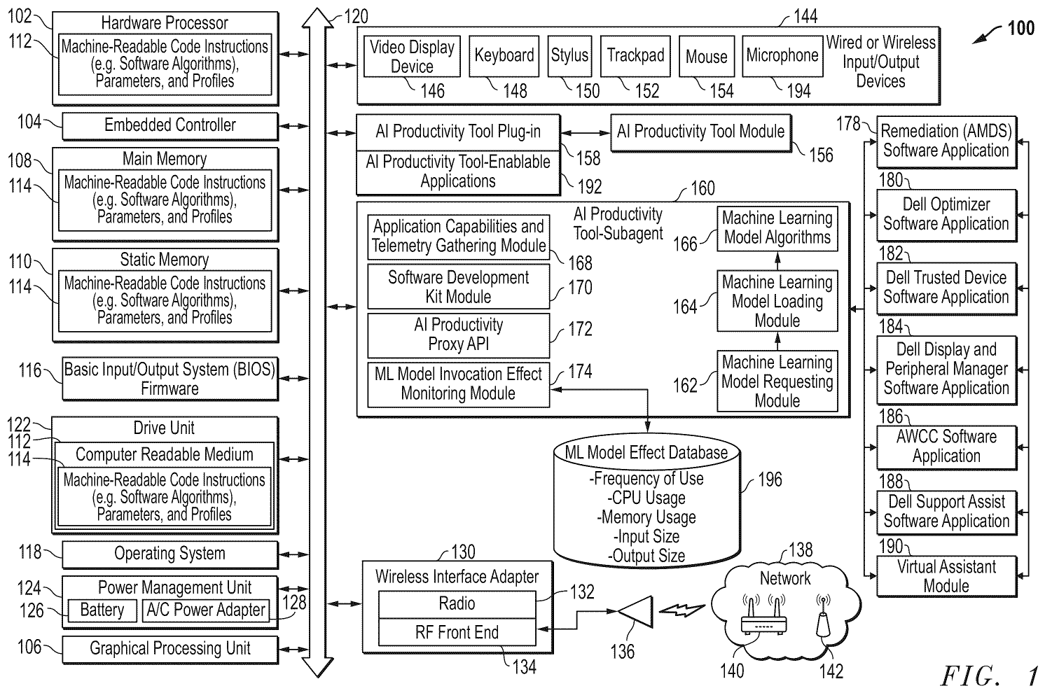

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 140, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 108, (volatile (e.g., random-access memory, etc.), or static memory 110, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU), an audio processing unit (APU), or any combination thereof. It is appreciated that the information handling system 100 may include any number of hardware processing devices described herein. Computer readable code instructions stored in main memory 108 (e.g., RAM) quickly accessible by hardware processing resources using that main memory 108. Computer-readable program code instructions stored in static memory 110, main memory 108, or drive unit 122 may be “cold” and latency may be involved in invoking such computer-readable program code instructions to main memory 108 according to embodiments herein. Additional components of the information handling system 100 may include one or more storage devices such as static memory 110 or drive unit 122. The information handling system 100 may include or interface with one or more communications ports for communicating with external devices, as well as various input and output (I/O) devices 144, such as a mouse 154, a trackpad 152, a stylus 150, a keyboard 148, a video/graphics display device 146, a microphone 194, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 114 that may operate on servers or systems, remote data centers, or on-box in individual client information handling systems according to various embodiments herein. In some embodiments, it is understood any or all portions of instructions (e.g., software algorithms), parameters, and profiles 114 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 108, static memory 110, and disk drive unit 122 (volatile (e.g., random-access memory, etc.), nonvolatile memory (read-only memory, flash memory etc.) or any combination thereof or other memory with computer readable medium 112 storing instructions (e.g., software algorithms), parameters, and profiles 114 executable by the hardware processor 102 (e.g., central processing unit), NPU, APU, EC 104, GPU 106, or any other hardware processing device. The information handling system 100 may also include one or more buses 120 operable to transmit communications between the various hardware components such as any combination of various I/O devices 144 as well as between hardware processors 102, an EC 104, the operating system (OS) 118, the basic input/output system (BIOS) 116, the wireless interface adapter 130, or a radio module, among other components described herein. In an embodiment, the hardware processor 102, EC 104, and/or GPU 106, NPU, APU may execute one or more bus drivers in order to transmit this data between the information handling system 100 and the input/output devices 144 described herein. In an embodiment, the information handling system 100 may be in wired or wireless communication with the I/O devices 144 such a keyboard 148, a mouse 154, video display device 146, stylus 150, trackpad 152, microphone 194, among other peripheral devices.

As described herein, the information handling system 100 further includes a video/graphics display device 146. The video/graphics display device 146 in an embodiment may function as a liquid crystal display (LCD), an organic light emitting diode (OLED), a flat panel display, or a solid-state display. It is appreciated that the video/graphics display device 146 may be wired or wireless and may be an external video/graphics display device 146 that allows a user to increase the desktop area by extending the desktop in an embodiment. Additionally, as described herein, the information handling system 100 may include or be operatively coupled to a cursor control device (e.g., a trackpad 152, or gesture or touch screen input), a stylus 150, and/or a keyboard 148, among others that allows the user to interface with the information handling system 100 via the video/graphics display device 146. Information handling system 100 may also be operatively coupled to a wired or wireless input/output device 144 or other hardware devices that may include a hardware processing device such as a hardware processor, microcontroller, or other hardware processing resource. Various drivers and hardware control device electronics may be operatively coupled to operate the I/O devices 144 according to the embodiments described herein. The present specification contemplates that the I/O devices 144 may be wired or wireless.

A network interface device of the information handling system 100 may be wired or wireless such as shown with wireless interface adapter 130 that can provide wireless connectivity among devices such as with Bluetooth® or to a network 138, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 140 or base station 142 used to operatively couple the information handling system 100 to a network 138 via a wireless interface adapter 130. In a specific embodiment, the network 138 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 130 may include one or more RF (RF) subsystems (e.g., radio 132) with transmitter/receiver circuitry, modem circuitry, one or more antenna RF (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, a hardware processing resource executing computer-readable program code instructions of software, or firmware, or dedicated hardware implementations such as application specific integrated circuits, programmable logic arrays and other hardware devices may be constructed to implement one or more of some systems and methods described herein. The apparatus and systems of various embodiments may broadly include a variety of electronic and computer systems such as one or a plurality of information handling systems 100 herein. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 114 or receives and executes computer-readable program code instructions, parameters, and profiles 114 responsive to a propagated signal, so that a hardware device connected to a network 138 may communicate voice, video, or data over the network 138. Further, the computer-readable program code instructions, parameters, and profiles 114 may be transmitted or received over the network 138 via the network interface device or wireless interface adapter 130.

The information handling system 100 may include a set of computer-readable program code instructions, parameters, and profiles 114 that may be executed to cause the computer system to perform any one or more of the methods or computer-based functions disclosed herein. For example, computer-readable program code instructions, parameters, and profiles 114 may be executed by a hardware processor 102, GPU 106, EC 104 or any other hardware processing resource and may include software agents, or other aspects or components used to execute the methods and systems described herein. Various software modules comprising application computer-readable program code instructions, parameters, and profiles 114 may be coordinated by an OS 118, and/or via an application programming interface (API) include a unified device API described herein. An example OS 118 may include Windows®, Android®, and other OS types. Example APIs may include Win 32, Core Java API, or Android APIs.

In an embodiment, the information handling system 100 may include a disk drive unit 122. The disk drive unit 122 and may include machine-readable program code instructions, parameters, and profiles 114 in which one or more sets of machine-readable program code instructions, parameters, and profiles 114 such as firmware or software can be embedded to be executed by the hardware processor 102 (e.g., CPU) or other hardware processing devices such as a GPU 106, an EC 104, an NPU, an APU, or other microcontroller unit to perform the processes described herein. Similarly, main memory 108 and static memory 110 may also contain a computer-readable medium for storage of one or more sets of machine-readable program code instructions, parameters, or profiles 114 described herein. The disk drive unit 122 or static memory 110 also contain space for data storage. Further, the machine-readable program code instructions, parameters, and profiles 114 may embody one or more of the methods as described herein. In a particular embodiment, the machine-readable program code instructions, parameters, and profiles 114 may reside completely, or at least partially, within the main memory 108, the static memory 110, and/or within the disk drive 122 during execution by the hardware processor 102, EC 104, or GPU 106 of information handling system 100.

Main memory 108 or other memory of the embodiments described herein may contain computer-readable medium (not shown), such as RAM in an example embodiment. An example of main memory 108 includes random access memory (RAM) such as static RAM (SRAM), dynamic RAM (DRAM), non-volatile RAM (NV-RAM), or the like, read only memory (ROM), another type of memory, or a combination thereof. Static memory 110 may contain computer-readable medium (not shown), such as NOR or NAND flash memory in some example embodiments. The applications and associated APIs, for example, may be stored in static memory 110 or on the disk drive unit 122 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 124 (a.k.a. a power supply unit (PSU)). The PMU 124 may include a hardware controller and executable machine-readable code instructions to manage the power provided to the components of the information handling system 100 such as the hardware processor 102 and other hardware components described herein. The PMU 124 may control power to one or more components including the one or more drive units 122, the hardware processor 102 (e.g., CPU), the EC 104, the GPU 106, a video/graphic display device 146, or other wired I/O devices 144 such as the mouse 154, the stylus 150, the keyboard 148, and the trackpad 152 and other components that may require power when a power button has been actuated by a user. In an embodiment, the PMU 124 may monitor power levels and be electrically coupled to the information handling system 100 to provide this power. The PMU 124 may be coupled to the bus 120 to provide or receive data or machine-readable code instructions. The PMU 124 may regulate power from a power source such as the battery 126 or AC power adapter 128. In an embodiment, the battery 126 may be charged via the AC power adapter 128 and provide power to the components of the information handling system 100, via wired connections as applicable, or when AC power from the AC power adapter 128 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool module 156 and an AI productivity tool subagent 160 to select among a plurality of machine learning (ML) model algorithms 166 for use with execution of a plurality of AI productivity tool-enablable software applications 192 according to another embodiment of the present disclosure. As described herein, the AI productivity tool module 156 and AI productivity tool subagent 160 may be executed by a hardware processor 102 on the information handling system 100 thereby allowing the methods described herein to be carried out on-the-box such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein.

The AI productivity tool module 156 may include any artificial intelligence-based productivity tool to assist in interface and execution of one or more AI productivity tool-enablable software applications 192 or inputs and responses from a user of an information handling system 100. The AI productivity tool module 156 may be loaded on-the-box by a manufacturer in software and may include chatbot features, virtual assistant features, and other artificial intelligence features that allow a user to provide input to the information handling system 100 and, with generative artificial intelligence processing of a user input query execute one or more capabilities that include operations, functions, software services, or responses using one or more AI productivity tool-enablable software applications 192. Examples of some AI productivity tool modules 156 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 100 may include any proprietary AI productivity tool module 156 installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool module 156 with its AI productivity tool plug-in 158 and monitor for user input for a user query at a microphone 194, keyboard 148, or other input device for the AI productivity tool module 156 to engage in AI productivity actions pursuant to the user query input.

The AI productivity tool module 156, executing on the hardware processor 102 or other hardware processing resource (e.g., EC 104, GPU 106, APU, or NPU), may interface with other hardware components and with the AI productivity tool-enablable software applications 192 and one or more ML module algorithms 166 the information handling system 100 via an AI productivity tool plug-in 158. The AI productivity tool plug-in 158 may be any software or firmware that allows the AI productivity tool module 156 to perform those actions at the information handling system 100 based on user query input (e.g., typed or spoken words) from the user. The AI productivity tool plug-in 158 may be used by the AI productivity tool module 156 and AI productivity tool subagent 160 to interface with any number of AI productivity tool-enablable software applications 192 executing or executable on the information handling system 100 according to embodiments herein.

The information handling system 100 also includes the AI productivity tool subagent 160 of the AI productivity tool module 156. The AI productivity tool subagent 160 may be any software and/or firmware executable by the hardware processor 102 of the information handling system 100 to interface one or more of the plurality of the AI productivity tool-enablable software applications 159 (such as a remediation (AMDS) software application 178, Dell® Optimizer® software application 180, Dell® Trusted Device® software application 182, Dell® Display and Peripheral Manager® software application 184, AWCC software application 186, Dell® Support Assist® software application 188, virtual assistant module 190) to provide AI enabled capabilities within those AI productivity tool-enablable software applications (e.g., 178, 180, 182, 184, 186, 188, 190) for responsive operations, functions, software services, or response to user input queries. In an embodiment, the computer-readable program code instructions of the software applications (e.g., AI productivity tool-enablable software applications 192) and modules described herein (e.g., 178, 180, 182, 184, 186, 188, 190) may operate wholly “on-box” within the information handling system 100 or be sub-agents on-box for interfacing with remote software systems executing at remote server locations. In an embodiment, the AI productivity tool subagent 160 may be used to direct the execution of various modules in support of the AI productivity tool-enablable software applications 192 described herein. Additionally, the AI productivity tool subagent 160 may be provided with access to the BIOS and OS of the information handling system 100 to conduct the AI productivity actions pursuant to the user's query input provided via the AI productivity tool module 156 or with an interface of one of the AI productivity tool-enablable software applications 192. Examples of AI productivity tool-enablable software applications 192 may include, for example, Dell® Trusted Device® software application 182, a remediation Dell® APEX Managed Device Service (AMDS)® software application 178, Alienware Command Center (AWCC)® software application 186, Dell® Optimizer® software application 180, Dell® Display and Peripheral Manager software application 184, and a virtual assistant module 190, among others.

In an embodiment, the hardware processor 102 or other hardware processing resource (e.g., EC 104, GPU 106, CPU, APU, or NPU) executing computer-readable program code instructions of the AI productivity tool subagent 160 may include a machine learning model requesting module 162. The machine learning model requesting module 162 may be used by the AI productivity tool subagent 160 to, when prompted via the AI productivity tool plug-in 158, fulfill a “contract” of an AI productivity tool-enablable software applications 192 requesting an ML model algorithm 166 by selecting a specific machine learning (ML) model algorithm 166 to fulfill that contract. The “contract” described herein defines the requirements that a selected ML model algorithm is to have in order to be able receive a specific type of input from the AI productivity tool-enablable software application 192 or AI productivity tool subagent 160 and to provide a specific type of output to the AI productivity tool-enablable software application 192 or AI productivity tool subagent 160. For example, a contact may include data that describes that audio data is to be used as input and, as output, text is to be received from the selected ML model algorithm 166. This defines, therefore, that the ML model algorithm 166 must be capable of completing speech-to-text conversions with the audio data received from, for example, a microphone 192 and further defines that the ML model algorithm 166 must provide output in the form of text. In another embodiment, the contract may describe that the input received is to be data associated with one or more peripheral devices managed by, for example, a peripheral device managing software application such as Dell® Display and Peripheral Manager Software Application 184 and may include data such as current settings for a peripheral device, battery levels at the peripheral devices, current wired or wireless communication protocols used by the peripheral device among others. In this example embodiment, the output required may include data describing suggested changes to settings associated with the peripheral devices that would increase the functionalities of a peripheral device.

During operation for example, the machine learning model requesting module 162 may request that one or more machine learning model algorithms 166 be loaded by the machine learning model loading module 164 such that, for example, the voice input queries from the user may be processed through a speech recognition ML model algorithm and text or speech may then be processed through a natural language ML model algorithm in order to determine an intent value of the user's query input. It is appreciated that these machine learning model algorithms 166 may include one or more ML model algorithms that work together to both decipher the user's intent to a query intent value defined according to the ML model algorithm 166 while also conducting operations at the information handling system 100 to provide feedback to the user such as creating AI generated text at a word processing application or for an audio system being executed by the hardware processor 102 on the information handling system 100, for example. Further feedback may include AI responsive actions or operations by one or more AI productivity tool-enablable software applications 192 in embodiments herein.

In an embodiment, hardware processor 102 executing computer-readable program code instructions of the AI productivity tool subagent 160 also includes a software development kit (SDK) module 170. The SDK module 170 may include any computer-readable program code instructions that is executed by the hardware processor to request that a machine learning model algorithm 166 be provided during the execution of an AI productivity tool-enablable software application 192 to support a determination of capabilities and executing those capabilities in response to a user input query. For example, where a user interacts with the graphical user interface (GUI) of an AI productivity tool-enablable software application 192 being executed on the video display device 146 and provides an input query via the GUI such that the AI productivity tool 156 is invoked to process the input query, the SDK module 170 then requests from the AI productivity tool subagent 160 a specific ML model algorithm 166 to be loaded and executed on a first hardware processing device of the information handling system as requested by the AI productivity tool-enablable software application 192 for a response. The selection by the user of the AI productivity tool 156 within the AI productivity tool-enablable software application 192, therefore, sets off a process by which a specific ML model algorithm 166 is selected and loaded to RAM 108, if not pre-loaded, or maintained in RAM 108 and then executed in order to provide to the user the ability to provide query input via voice, text, or other input at the information handling system 100 and in order to receive AI generated output via that or other AI productivity tool-enablable software application 192.

In a specific example, the user may be drafting a lengthy document or email and may select a speech-to-text AI productivity tool available within the word processing application (e.g., Microsoft® Word®) or email (e.g., Microsoft® Outlook®) application (e.g., both examples of an AI productivity tool-enablable software application 192). Upon finding a capability intent value that meets the requested user query to receive speech and generate text, the AI productivity tool-enablable software application 192 accesses the AI productivity tool subagent 160 of the AI productivity tool 156. The selection of this speech-to-text AI productivity tool causes the AI productivity tool subagent 160 to execute the SDK module 170 in order to begin the process of communicating this request to a machine learning model requesting module 162 for handling of that request. In an embodiment, the SDK module 170 may present the request for the ML model algorithm 166 such that a specific type of ML model algorithm 166 that can perform the task of receiving speech audio query input from the user (e.g., via the microphone 194) and converting it to text for incorporation into the document or email of one of the AI productivity tool-enablable software applications 192 being executed on the information handling system 100 at the hardware processing device (e.g., hardware processor 102, EC 104, GPU 106, NPU, APU, etc.).

Other examples of an AI productivity tool-enablable software application 192 may include an updating software, virus protection software, and setting optimization software such as Dell® SupportAssist® module executable by the hardware processor 102 or other hardware processing resource of the information handling system 100 (e.g., CPU, NPU, APU, GPU, etc.). With SupportAssist® (e.g., the Dell® SupportAssist® software application 188), for example, a user may provide query input via, for example, the microphone 194 requesting information related to a setting associated with the information handling system 100. A query from a user is processed to a query intent value which is then correlated to a capability intent value for a SupportAssist® capability. Thus, capabilities of SupportAssist® may include, for example, virus protection capabilities, setting manipulation capabilities, and software updating capabilities. These capabilities may each be detected and gathered via the execution of the AI productivity tool-enablable software application capabilities and telemetry gathering module 168 for use and categorization of these capabilities as described herein. Still further, other capabilities data associated with the execution of an AI productivity tool-enablable software application 192 invoking an ML model algorithm 166 (e.g., invoked by the SupportAssist® AI productivity tool-enablable software application 192) may include the username of the user requesting the execution of SupportAssist® such that a usage may be tracked to assist with usage trends.

Additional examples of an AI productivity tool-enablable software application 192 may include Dell® Display®/Peripheral Manager® software application 184. The Dell® Display®/Peripheral Manager® software application 184 may have capabilities that include optimization of screen resolution, refresh rates, and gamma correction as well as webcam settings, mouse 154 settings, keyboard 148 settings, stylus 150 settings, microphone 194 settings, and trackpad 152 settings, among other settings and connections associated with the wired or wireless input/output devices 144 each of which may define a capability associated with the execution of the computer-readable program code instructions of the Dell® Display®/Peripheral Manager® software application 184. Again, these capabilities associated with the execution of the Dell® Display®/Peripheral Manager® software application 184 may be gathered by the AI productivity tool-enablable software application capabilities and telemetry gathering module 168 for later categorization as described herein. It is appreciated that any AI productivity tool-enablable software application 192 may provide a listing of capabilities to be gathered by the AI productivity tool-enablable software application capabilities and telemetry gathering module 168 and may include, for example, Dell® Trusted Device® software application, a remediation Dell® APEX Managed Device Service (AMDS)® software application, Alienware Command Center (AWCC)® software application, among others. The capabilities of each of these AI productivity tool-enablable software applications 192 may be gathered via execution, by the hardware processor 102 or any other hardware processing device, of the AI productivity tool-enablable software application capabilities and telemetry gathering module 168. It is appreciated that each of these AI productivity tool-enablable software applications 192 may also include their own AI productivity tool enablable software plug-ins 158 that interfaces with one or more AI productivity tool modules 156 to receive query input from the user and engage in AI productivity operations via the AI productivity tool 156 as described herein.

Along with the collection of the capability data prior to the invocation of the ML model algorithm 166 by the AI productivity tool-enablable software application 192, telemetry data may also be gathered via execution of the computer-readable program code instructions of a ML model invocation effect monitoring module 174. Execution of the computer-readable program code of the ML model invocation effect monitoring module 174 may cause effects from the execution of the AI productivity tool-enablable software application 192 using the ML model algorithm 166 on the operation of the information handling system 100 as well as resource requirements associated with that execution. This telemetry data may include data associated with the invocation of the ML model algorithm 166 and may further include, in an embodiment, historical data describing how long a previous execution of SupportAssist® 188 or other AI productivity tool-enablable software application 192 and its ML model algorithm 166 has taken, any size of data required for input into the ML model algorithm 166 invoked by the execution of the computer-readable program code of SupportAssist® 188 or other AI productivity tool-enablable software application 192 and its ML model algorithm 166, as well as the size of the data expected as output from the ML model algorithm 166. It can be appreciated that as the size of the input data and output data into and received out of the execution of the ML model algorithm 166 increases the consumption of resources such a processing resources at the information handling system 100 are increased thereby increasing the latency of operating the information handling system 100 and the hardware processors (e.g., hardware processor 102, GPU 106, EC 104, APU, NPU, etc.) executing these and other software application on information handling systems. This data, in an embodiment, may be provided to the application capabilities and telemetry gathering module 168 to determine if the execution of the computer-readable program code instructions of a first ML model algorithm 166 of the AI productivity tool-enablable software application 192 should be reprioritized relative to other AI productivity tool-enablable software applications 192 and their respective ML model algorithms 166 being executed on the information handling system.

For example, a first AI productivity tool-enablable software application 192 that utilizes a specific first ML model algorithm 166 above a threshold number of times or threshold period of time may be throttled so that a second or other AI productivity tool-enablable software applications 192 with a second or other ML model algorithm 166 may operate. In another example embodiment, policies (e.g., policies created by an ITDM) that define if and when a first ML model algorithm 166 invoked by a first AI productivity tool-enablable software application 192 is deprioritized or prioritized relative to a second or other ML model invoked by another or second AI productivity tool-enablable software application such that hardware processing resources are or are not reserved for the execution of the first ML model algorithm 166. In this embodiment, the first ML model algorithm 166 invoked by a first AI productivity tool-enablable software application may be prioritized based on a higher frequency of the invocation of the first ML model algorithm 166. In another specific example embodiment, ML model algorithms 166 invoked by AI productivity tool-enablable software applications 192 that are executed in a user-mode and service user interface actions directly that are viewed and active with a user may be prioritized over other ML model algorithms 166 of other AI productivity tool-enablable software applications 192 that do not involve direct observation by a user via a GUI such that the user experience is not reduced by operation of the other ML model algorithm 166 execution for the other AI productivity tool-enablable software applications 192 that may operate in the background.

It is appreciated that any execution of the computer-readable program code instructions of any ML model algorithm 166 by any AI productivity tool-enablable software application 192 may be cither prioritized or deprioritized depending on, for example, certain settings and described system policies set for the operation of the information handling system 100. For example, where a user or an ITDM has selected a setting on the information handling system 100 to prioritize conservation of battery power, those AI productivity tool-enablable software applications 192 invoking certain ML model algorithms 166 may be deprioritized where the execution of those AI productivity tool-enablable software applications 192 and ML model algorithms 166 increase processing resource consumption and thereby require additional power from, for example, a battery 126 of the information handling system 100. Other system operating policies for the information handling system 100 may be implemented for executing priorities of ML model algorithms 166 on the information handling system 100 and can even be combined priority policies, such as a priority assigned to frequently involved ML model algorithms 166 as well as to priority for responding to user-facing query inputs.

In an embodiment, the execution of the computer-readable program code instructions of the ML model invocation effect monitoring module 174 may cause a detected ML model effect and detected telemetry data for conditions of the detected effect associated with the execution of the ML model algorithm 166 to be stored on an ML model effect database 196. Again, the telemetry data stored within the ML model effect database 196 may include a frequency of use of a ML model algorithm 166 by any given AI productivity tool-enablable software application 192, the identification of AI productivity tool-enablable software applications 192 and ML model algorithms 166, the identification of the user operating the information handling system 100 and causing the execution of the AI productivity tool-enablable software application 192 and the ML model algorithm 166, the amount of processing resources consumed during the execution of the ML model algorithm 166 (e.g., CPU processing resource consumption), the amount of RAM occupied by the computer-readable program code instructions of the ML model algorithm 166, data input size for each ML model algorithm 166, and data output size for each ML model algorithm 166. Each of this telemetry data may be associated with execution of an identified an ML model algorithm 166 and, in an embodiment, an identified AI productivity tool-enablable software application 192 that invoked those ML model algorithms 166. In an embodiment, the ML model effect database 196 may be accessible to the application capabilities and telemetry gathering module 168 and ML model invocation effect monitoring module 174 as described herein in order to determine whether to prioritize or deprioritize the execution of any given ML model algorithm 166 invoked by any given AI productivity tool-enablable software application 192 according to system operating policies established by a user or ITDM for the information handling system 100.

The systems and methods described herein use data being used as input to a ML model algorithm 166 and associated with the AI productivity tool-enablable software application 192 in order to monitor for the effects that the execution of the AI productivity tool-enablable software application 192 and invoked ML model algorithms 166 have on the operation of the information handling system 100 including the hardware processing resources consumed. These systems and methods allow for the AI productivity tool subagent 160 to monitor for extreme consumption of hardware resources within the information handling system 100 or otherwise prioritize the execution of the ML model algorithms 166 invoked by AI productivity tool-enablable software applications 192 according to one or more priority policies such that a user experience is beneficially increased.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

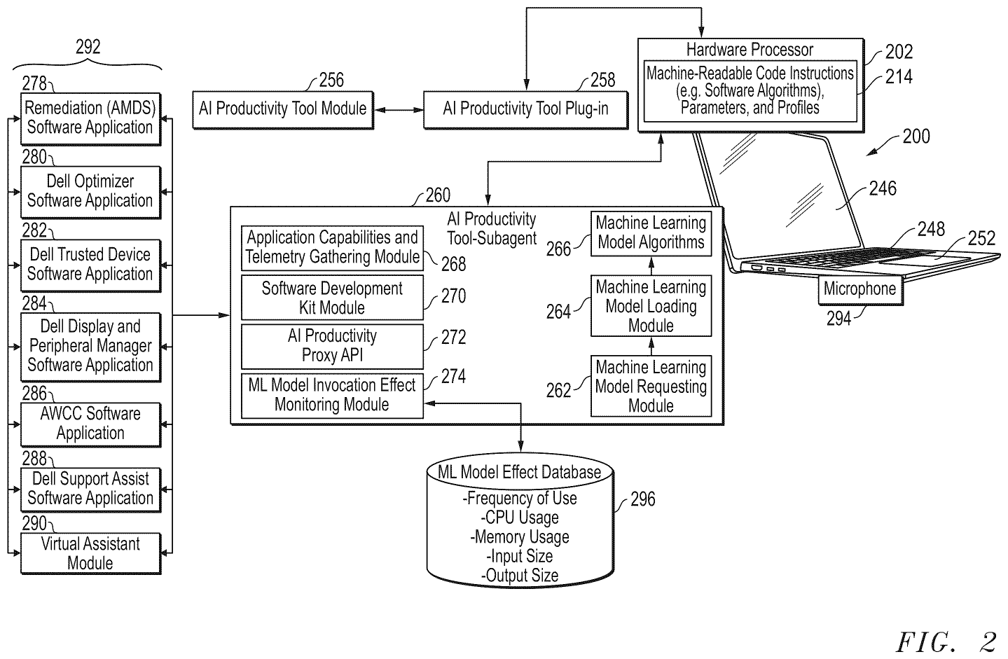

FIG. 2 is a graphic and block diagram illustrating an information handling system that includes an AI productivity tool module 256 and an AI productivity tool subagent 260 to select among and prioritize execution of one or more ML model algorithms 266 invoked by a plurality of AI productivity tool-enablable software applications 292 according to another embodiment of the present disclosure. As described herein, the AI productivity tool module 256 and AI productivity tool subagent 260 may be executed by a hardware processor 202 on the information handling system 200 thereby allowing the methods described herein to be carried out on-the-box such that a wireless connection to a network is not necessary for operation of the method. In another embodiment, some modules, databases, and/or processing resources may be maintained on a remote server such that a wireless connection can be made with these remote servers and the method may be implemented as described herein.

In FIG. 2, the information handling system 200 is shown as a laptop-type information handling system 200. However, the present specification contemplates that the information handling system 200 may be any type of information handling system as described herein. The information handling system 200 in FIG. 2 includes a video display device 246 used to provide output to the user. The information handling system 200 further includes a keyboard 248 and a trackpad 252 used by the user to provide input to the information handling system 200. In an embodiment, a microphone 294 may be included to receive audio input from a user to be used as input into a ML model algorithm 266 invoked by an AI productivity tool-enablable software application 292 as described herein.

As described in embodiments herein, the information handling system 200 includes an AI productivity tool module 256 and an AI productivity tool subagent 260 to select among a plurality of AI productivity tool-enablable software applications 292 for responsive capabilities to a user input query according to another embodiment of the present disclosure. As described herein, the AI productivity tool module 256 and AI productivity tool subagent 260 may be executed by a hardware processor 202 on the information handling system 200 to receive and process a user input query, including embedding it into a query intent value within a multi-axis vector space in embodiments. Further, the AI productivity tool module 256 and AI productivity tool subagent 260 execute to determine one or more capabilities of an AI productivity tool-enablable software applications 292 that may be responsive to the input query based on executing similarity correlation between a capability intent value and the query intent value in embodiments herein.

The AI productivity tool module 256 may include any artificial intelligence-based productivity tool to assist in interface and execution of one or more AI productivity tool-enablable software applications 292 or inputs from and responses to a user of an information handling system 200. The AI productivity tool module 256 may be loaded on-the-box by a manufacturer in software and may include chatbot features, virtual assistant features, and other artificial intelligence features that allow a user to provide input, such as query input, to the information handling system 200 and, with generative artificial intelligence processing that query input to determine the query input intent value. Then the AI productivity tool module 256 correlates the query intent value to a closest correlated capability intent value to commence executing of one or more capabilities that include operations, functions, software services, or responses using one or more AI productivity tool-enablable software applications 292. Examples of some AI productivity tool modules 256 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 200 may include any proprietary AI productivity tool module 256 such as loaded by a manufacturer and used to interface with the information handling system 200 and orchestrate the responsive operations thereon. In various embodiments, the hardware processor 202 or other alternative hardware processing resources of the information handling system 200 may execute computer-readable program code instructions of the AI productivity tool module 256 with its AI productivity tool plug-in 258 and monitor for user input at a microphone 294, keyboard 248, or other input device for the AI productivity tool module 256 to engage in AI productivity actions pursuant to the user input. In other embodiments, the AI productivity tool module 256 may monitor an input interface (audio, text, or other) query of one of the AI productivity tool-enablable software applications 292 to receive a user input query.

The AI productivity tool module 256, executing on the hardware processor 202 or other hardware processing resource (e.g., EC, GPU, APU, or NPU), may interface with other hardware components and with the AI productivity tool-enablable software applications 292 which may require invoking one or more ML module algorithms 266 on the information handling system 200 via an AI productivity tool plug-in 258. The AI productivity tool plug-in 258 may be any software or firmware that allows the AI productivity tool module 256 to perform those actions at the information handling system 200 based on input (e.g., typed, or spoken, words, or other) from the user. The AI productivity tool plug-in 258 may be used by the AI productivity tool module 256 and AI productivity tool subagent 260 to interface with any number of AI productivity tool-enablable software applications 292 executing or executable on the information handling system 200.

The information handling system 200 also includes an AI productivity tool subagent 260 as part of or executing with the AI productivity tool module 256. The AI productivity tool subagent 260 may be any software and/or firmware executable by the hardware processor 202 of the information handling system 200 to interface one or more of a plurality of the AI productivity tool-enablable software applications 292 (such as a remediation (AMDS) software application 278, Dell® Optimizer® software application 280, Dell® Trusted Device® software application 282, Dell® Display and Peripheral Manager® software application 284, AWCC software application 286, Dell® Support Assist® software application 288, virtual assistant module 290) to provide AI enabled capabilities within those AI productivity tool-enablable software applications (e.g., 278, 280, 282, 284, 286, 288, 290) for responsive operations, functions, software services, or responses to user input queries. In an embodiment, the computer-readable program code instructions of the software applications (e.g., AI productivity tool-enablable software applications 292) and modules described herein (e.g., 262, 264, 268, 270, 272, and 274) as well as a plurality of ML model algorithms 266 may operate wholly “on-box” within the information handling system 200 or be sub-agents on-box for interfacing with remote software systems executing at remote server locations. In an embodiment, the AI productivity tool subagent 260 may be used to direct the execution of various modules (e.g., 262, 264, 268, 270, 272, and 274) in support of the AI productivity tool-enablable software applications 292 described herein. Additionally, the AI productivity tool subagent 260 may be provided with access to the BIOS and OS of the information handling system 200 to conduct the AI productivity actions pursuant to the user's input provided at the AI productivity tool module 256. Examples of AI productivity tool-enablable software applications 292 may further include, for example, Dell® Trusted Device® software application 282, a remediation Dell® APEX Managed Device Service (AMDS)® software application 278, Alienware Command Center (AWCC)® software application 286, Dell® Optimizer® software application 280, Dell® Display and Peripheral Manager software application 284, and a virtual assistant module 290, among others.

In an embodiment, the hardware processor 202 or other hardware processing resource (e.g., EC, GPU, CPU, APU, or NPU) executing computer-readable program code instructions of the AI productivity tool module 256 with the AI productivity tool subagent 260 may include computer-readable program code instructions a machine learning model requesting module 262. The machine learning model requesting module 262 may be used by the AI productivity tool subagent 260 to, when prompted via the AI productivity tool plug-in 258, fulfill a “contract” for access to a commonly-available ML model algorithm 266 on the information handling system to meet the computing requirements of a AI productivity tool-enablable software applications 292 for responding to a user query input by requesting a specific machine learning (ML) model algorithm 266 among a plurality of commonly-available ML model algorithms in the information handling system 200. During operation for example, a hardware processor (e.g., 202, GPU, NPU, APU, etc.) executing computer-readable program code instructions of the machine learning model requesting module 262 may request that one or more machine learning model algorithms 266 be loaded by the machine learning model loading module 264 such that, for example, the voice input from the user may be processed through a speech recognition ML model algorithm and the text or speech converted to text may then be processed through a natural language embedding ML model algorithm in order to determine a query intent value of the user's query input. It is appreciated that these machine learning model algorithms 266 may include one or more ML model algorithms that work together to both decipher audio and determine the user's intent with a query intent value defined according to the ML model algorithm 266 while also conducting operations at the information handling system 200 to provide the AI feedback requested as well as conduct other software and hardware operations of the information handling system 200. The AI feedback responsive to a query input to the user may include creating AI generated text at a word processing application or for an audio system being executed by the hardware processor 202 on the information handling system 200, for example. Other AI feedback pursuant to correlating capabilities of one or more AI productivity tool-enablable software applications 292 may include responsive hardware operations, software services, or other responses.

In an embodiment, a hardware processor 202 executing computer-readable program code instructions of the AI productivity tool subagent 260 also includes a software development kit (SDK) module 270. The SDK module 270 may include any computer-readable program code instructions that is executed by the hardware processor 202 to request that a machine learning model algorithm 266 be provided during the execution of an AI productivity tool-enablable software application 292 to support a determination of capabilities and executing those capabilities in response to a user input query. For example, where a user interacts with the graphical user interface (GUI) of an AI productivity tool-enablable software application 292 being executed on the video display device 246 and inputs a query to trigger an AI productivity tool 256, the SDK module 270 then requests from the AI productivity tool subagent 260 a specific ML model algorithm 266 to be loaded and executed on a first hardware processing device of the information handling system. The selection by the user of the AI productivity tool 256 with a query via the AI productivity tool-enablable software application 292, therefore, sets off a process by which a specific ML model algorithm 266 is loaded to RAM 208 if not preloaded or maintained in RAM 208 and then executed in order to provide to the user the ability to provide input via voice, text, or other input at the information handling system 200 and in order to receive AI generated output as AI feedback.

In a specific example, the user may be drafting a lengthy document or email and may select a speech-to-text AI productivity tool available within the word processing application (e.g., Microsoft® Word®) or email (e.g., Microsoft® Outlook®) application (e.g., both examples of an AI productivity tool-enablable software application 292). Upon finding a capability intent value that meets a requested user query to receive speech and generate text, the AI productivity tool-enablable software application 292 accesses the AI productivity tool subagent 260 of the AI productivity tool 256. The selection of this speech-to-text AI productivity tool causes the AI productivity tool subagent 260 to execute the SDK module 270 in order to begin the process of communicating this request to a machine learning model requesting module 262 for handling of that request. In an embodiment, the SDK module 270 may present the request for the ML model algorithm 266 such that a specific type of ML model algorithm 266 that can perform the task of receiving speech audio query input from the user (e.g., via the microphone 294) and converting it to text for incorporation into the document or email of one of the AI productivity tool-enablable software applications 292 being executed on the information handling system 200 at the hardware processing device (e.g., hardware processor 202, EC, GPU, NPU, APU, etc.).

Other examples of an AI productivity tool-enablable software application 292 may include an updating software, virus protection software, and setting optimization software such as Dell® SupportAssist® module executable by the hardware processor 202 or other hardware processing resource of the information handling system 200 (e.g., CPU, NPU, APU, GPU, etc.). With SupportAssist® (e.g., the Dell® SupportAssist® software application 288), for example, a user may provide query input via, for example, the microphone 294 requesting information related to a setting associated with the information handling system 200. A query from a user is processed to a query intent value which is then correlated to a capability intent value for a SupportAssist® capability. Thus, capabilities of SupportAssist® may include, for example, virus protection capabilities, setting manipulation capabilities, and software updating capabilities. These capabilities may each be detected and gathered via the execution of the AI productivity tool-enablable software application capabilities and telemetry gathering module 268 for use and categorization of these capabilities as described herein. Still further, other capabilities data associated with the execution of an AI productivity tool-enablable software application 292 invoking an ML model algorithm 266 (e.g., invoked by the SupportAssist® AI productivity tool-enablable software application 292) may include the username of the user requesting the execution of SupportAssist® such that a usage may be tracked to assist with usage trends.

Additional examples of an AI productivity tool-enablable software application 292 may include Dell® Display®/Peripheral Manager® software application 284. The Dell® Display®/Peripheral Manager® software application 284 may have capabilities that include optimization of screen resolution, refresh rates, and gamma correction as well as webcam settings, mouse 254 settings, keyboard 248 settings, stylus settings, microphone 294 settings, and trackpad 252 settings, among other settings and connections associated with the wired or wireless input/output devices each of which may define a capability associated with the execution of the computer-readable program code instructions of the Dell® Display®/Peripheral Manager® software application 284. Again, these capabilities associated with the execution of the Dell® Display®/Peripheral Manager® software application 284 may be gathered by the AI productivity tool-enablable software application capabilities and telemetry gathering module 268 for later categorization as described herein. It is appreciated that any AI productivity tool-enablable software application 292 may provide a listing of capabilities to be gathered by the AI productivity tool-enablable software application capabilities and telemetry gathering module 268 and may include, for example, Dell® Trusted Device® software application, a remediation Dell® APEX Managed Device Service (AMDS)® software application, Alienware Command Center (AWCC)® software application, among others. The capabilities of each of these AI productivity tool-enablable software applications 292 may be gathered via execution, by the hardware processor 202 or any other hardware processing device, of the AI productivity tool-enablable software application capabilities and telemetry gathering module 268. It is appreciated that each of these AI productivity tool-enablable software applications 292 may also include their own AI productivity tool enablable software plug-ins 258 that interfaces with one or more AI productivity tool modules 256 to receive query input from the user and engage in AI productivity operations via the AI productivity tool 256 as described herein.

Along with the collection of the capability data prior to the invocation of the ML model algorithm 266 by the AI productivity tool-enablable software application 292, telemetry data may also be gathered via execution of the computer-readable program code instructions of a ML model invocation effect monitoring module 274. Execution of the computer-readable program code of the ML model invocation effect monitoring module 274 may cause effects from of the execution of the AI productivity tool-enablable software application 292 using the ML model algorithm 266 on the operation of the information handling system 200 as well as resource requirements associated with that execution. This telemetry data may include data associated with the invocation of the ML model algorithm 266 and may include, in an embodiment, historical data describing how long a previous execution of SupportAssist® 288 or other AI productivity too-enable software application 292 and its ML model algorithm 266 has taken, any size of data required for input into the ML model algorithm 266 invoked by the execution of the computer-readable program code of SupportAssist® 288 or other AI productivity tool-enablable software application 292 and its ML model algorithm 266, as well as the size of the data expected as output from the ML model algorithm 266. In an embodiment, this telemetry data may be gathered using any number of sensors or detectors that measure current operating telemetry data at the information handling system 200 that may include CPU functions, RAM memory occupancy levels, power levels, solid state memory occupancy levels, and temperature levels, among other telemetry data. In a specific example, a temperature measuring device may be operatively coupled to a battery or the CPU to measure the temperatures associated with those hardware devices. Still further, other computer-readable program code instructions of software modules may be executed to measure other telemetry data at other hardware devices such as software to track processor usage or BIOS tracking memory or solid state occupancy among others. It can be appreciated that as the size of the input data and output data into and received out of the execution of the ML model algorithm 266 increases the consumption of resources such a processing resources at the information handling system 200 are increased thereby increasing the latency of operating the information handling system 200 and the hardware processors (e.g., hardware processor 202, GPU, EC, APU, NPU, etc.) executing these and other software application and information handling systems.

As described herein, the telemetry data may be collected to determine conditions of the detected effect associated with the execution of any given ML model algorithm 266 and operation of an AI productivity tool-enablable software application 292. An example of this telemetry data may include the level of processing resources consumed via the execution of an ML model algorithm 266. It is appreciated that an increase in consumption of processing resources at, for example, a CPU, an increase in the CPU may be detected via sensors and software monitoring for a processor speed or processor utilization levels, use of CPU power consumption from a PMU, use of a temperature measuring device or other which may be provided to the ML model invocation effect monitoring module 274. Still further, it may also be appreciated that as increased amounts of hardware processing resources are used, power levels at a battery of the information handling system may be reduced and temperatures may increase at the battery. This measured telemetry data (e.g., as measured by the PMU and temperature measuring device) may also be transmitted to the ML model invocation effect monitoring module 274. The execution of the computer-readable program code of the OS and/or BIOS, in an example embodiment, may also be used to detect this telemetry data and provide this telemetry data to the ML model invocation effect monitoring module 274. Thus, in some embodiments, the execution of one or more ML model algorithms 266 on behalf of one or more AI productivity tool-enablable software applications 292 may affect the operation of the information handling system 200. These effects on operation of the information handling system 200 may be detected with the resulting telemetry data provided to the ML model invocation effect monitoring module 274 as described herein.

This telemetry data, in an embodiment, may be provided to the application capabilities and telemetry gathering module 268 to determine if the execution of the computer-readable program code instructions of a first ML model algorithm 266 with the AI productivity tool-enablable software application 292 should be reprioritized relative to other AI productivity tool-enablable software applications 292 and their respective ML model algorithms 266 being executed on the information handling system. In an example embodiment, multiple ML model algorithms 266 with multiple AI productivity tool-enablable software applications 292 may tax the resources of the information handling system 200 as other processing tasks are also to be conducted at the information handling system 200. As a result, the prioritization of the execution of any given ML model algorithm 166 may be required. Consequently, metadata may be assigned to each ML model algorithm 266 or a queue list of priority for plural ML model algorithms 266 may be formed by the ML model invocation effect monitoring module 274. With this assigned metadata or queue list of priority for ML model algorithms 266, the AI productivity tool-enablable software application capabilities and telemetry gathering module 268 may prioritize the AI productivity tool-enablable software applications 292 and their usage of one or more available ML model algorithms 266. The prioritization may be based on effects of running the ML model algorithm 266 on the information handling system, whether the AI productivity tool-enablable software application 292 invoking the ML model algorithm 266 is a user-facing software application or an AI productivity tool-enablable software applications 292 that is running in the background, and/or other user-defined or ITDM-defined policies regarding the execution of the ML model algorithms 266 to follow the prioritization defined by these policies.

For example, a first AI productivity tool-enablable software application 292 that utilizes a specific first ML model algorithm 266 above a threshold number of times or threshold period of time may be throttled so that a second or other AI productivity tool-enablable software applications 292 with a second or other ML model algorithms 266 may operate. In another example embodiment, ML algorithm execution system policy (e.g., policies created by an ITDM) may be implemented that define if and when a first ML model algorithm 266 invoked by a first AI productivity tool-enablable software application 292 is deprioritized or prioritized relative to a second or other ML model invoked by another or second AI productivity tool-enablable software application such that hardware processing resources are or are not reserved for the execution of the first ML model algorithm 266. In this embodiment, the first ML model algorithm 266 invoked by a first AI productivity tool-enablable software application may be prioritized based on a higher frequency of the invocation of the first ML model algorithm 266. In another specific example embodiment, ML model algorithms 266 invoked by AI productivity tool-enablable software applications 292 that are executed in a user-mode to service user interface actions directly and are viewed and active with a user may be prioritized over a second ML model algorithms 166 of a second AI productivity tool-enablable software applications 292 that do not involve direct observation by a user via a GUI in an embodiment. In this way, the user experience is not reduced by operation of that second ML model algorithm 266 execution for the second AI productivity tool-enablable software applications 292 that may operate in the background.

It is appreciated that any execution of the computer-readable program code instructions of any ML model algorithm 266 by any AI productivity tool-enablable software application 292 may be either prioritized or deprioritized depending on, for example, certain settings and described system policies set for the operation of the information handling system 200. For example, where a user or an ITDM has selected a setting on the information handling system 200 to prioritized conservation of battery power, those AI productivity tool-enablable software applications 292 invoking certain ML model algorithms 266 may be deprioritized where the execution of those AI productivity tool-enablable software applications 292 and ML model algorithms 266 increase processing resource consumption and thereby require additional power from, for example, a battery 226 of the information handling system 200. Other system operating policies for the information handling system 100 may be implemented for executing priorities of ML model algorithms 166 on the information handling system 100, including combinations of policies such as a priority assigned to frequently invoked ML model algorithms 266 and further consider ML model algorithms 266 executing to respond directly to user-facing query inputs, for example which may be prioritized in any way according to an ML algorithm execution system policy established by a user or ITDM.

In an embodiment, the execution of the computer-readable program code instructions of the ML model invocation effect monitoring module 274 may cause a detected ML model effect and gathered telemetry data and conditions associated with the execution of the ML model algorithm 266 to be stored on an ML model effect database 296. Again, the telemetry data stored within the ML model effect database 296 may include a frequency of use of a ML model algorithm 266 by any given AI productivity tool-enablable software application 292, the identification of AI productivity tool-enablable software applications 292 and ML model algorithms 266, the identification of the user operating the information handling system 200 and causing the execution of the AI productivity tool-enablable software application 292 and the ML model algorithm 266, the amount of processing resources consumed during the execution of the ML model algorithm 266 (e.g., CPU processing resource consumption), the amount of RAM occupied by the computer-readable program code instructions of the ML model algorithm 266, data input size for each ML model algorithm 266, and data output size for each ML model algorithm 266. Each of this telemetry data may be associated with the execution of an identified ML model algorithm 266 and, in an embodiment, an identified AI productivity tool-enablable software application 292 that invoked those one or more ML model algorithms 266. In an embodiment, the ML model effect database 296 may be accessible to the application capabilities and telemetry gathering module 268 and ML model invocation effect monitoring module 274 as described herein in order to determine whether to prioritize or deprioritize the execution of any given ML model algorithm 266 invoked by any given AI productivity tool-enablable software application 292 within an ML model priority list or queue in memory.

The systems and methods described herein use data being used as input to a ML model algorithm 166 and associated with the AI productivity tool-enablable software application 292 being used as input to a ML model algorithm 266 in order to monitor for the effects that the execution of the AI productivity tool-enablable software application 292 and invoked ML model algorithm 266 have on the operation of the information handling system 200 including the hardware processing resources consumed. These systems and methods allow for the AI productivity tool module 256 and subagent 260 to monitor for extreme consumption of hardware resources within the information handling system 200 or otherwise prioritize the execution of the ML model algorithm 266 invoked by an AI productivity tool-enablable software application 292 according to one or more priority policies such that a user experience is beneficially increased.

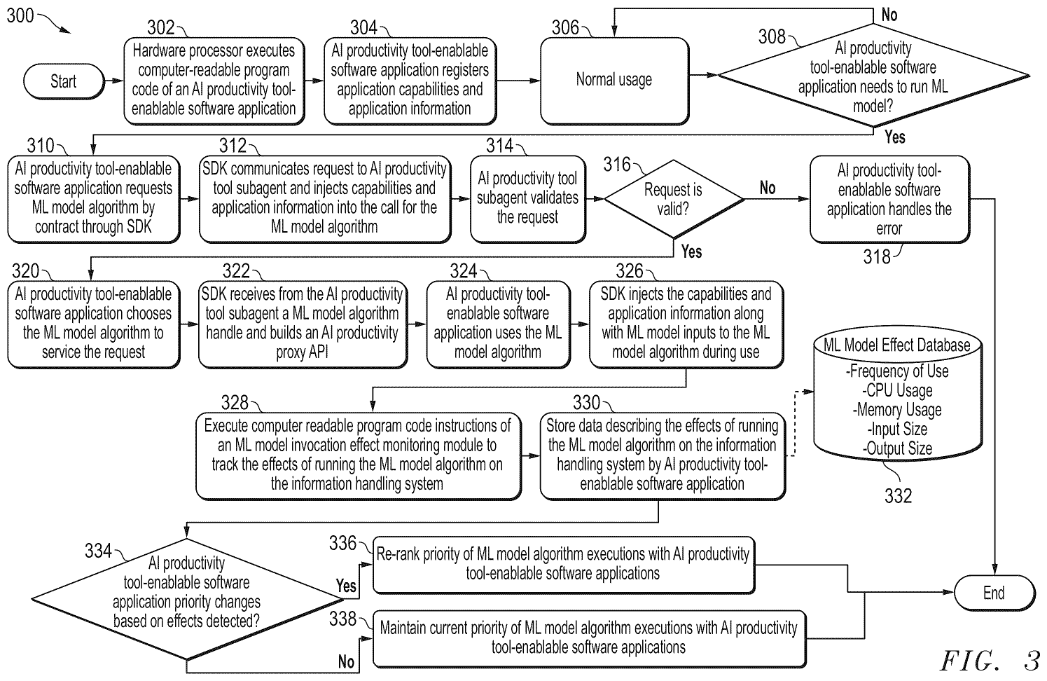

FIG. 3 is a flow diagram showing a method of prioritizing execution of AI productivity tool-enablable applications invoking machine learning models according to an embodiment of the present disclosure. The computer-readable program code instructions of each of the plurality of AI productivity tool-enablable software applications may be executed by a hardware processor of the information handling system such as a CPU, APU, NPU, GPU etc. Execution of code instructions of the AI productivity tool-enablable software applications may be initiated when, for example, a user interacts with an AI productivity tool associated with an AI productivity tool-enablable software application executing via one or more hardware processors on the information handling system.

During execution and in order to complete a capability of the AI productivity tool-enablable software application, the computer-readable program code instructions of an AI productivity tool-enablable software application may invoke one or more ML model algorithms that are also executed by a hardware processor of the information handling system in order to receive input and provide output to fulfill the contract of the AI productivity tool-enablable software application to process the query input or perform a response AI action with such a capability. During the operation of the method and systems described herein, computer-readable program code instructions of an application capabilities and telemetry gathering module and an ML model invocation effect monitoring module cooperate in order to discover the capabilities of the AI productivity tool-enablable software application and use those capabilities and other data (e.g., registerable capabilities, application information, user identification, application version, whether the application is a service-mode application or a user-mode application, etc.) to facilitate and prioritize among ML model algorithms to be executed based on a capability of an AI productivity tool-enablable software application or based on other applications that are operating on the information handling system. Still further the execution of the computer-readable program code instructions of the ML model invocation effect monitoring module allows the AI productivity tool subagent to monitor for extreme consumption of hardware resources via gathered telemetry data within the information handling system and prioritize the execution of the ML model algorithms invoked by the AI productivity tool-enablable software applications such that a user experience is increased.

During operation of the systems and methods described herein, the hardware processor of the information handling system may execute computer-readable program code instructions of an AI productivity tool-enablable software application capabilities gathering module. The execution of the AI productivity tool-enablable software application capabilities gathering module causes the hardware processor to gather capabilities, which may be published or descriptions of capabilities generated for each of the AI productivity tool-enablable software applications such as the Dell Optimizer® application, Dell® SupportAssist® module, or others in embodiments herein. For example, capabilities of the Dell Optimizer® application may include virus protection capabilities, setting manipulation capabilities, and software updating capabilities that may each be detected and gathered via the execution of the AI productivity tool-enablable software application capabilities gathering module for use and categorization of these capabilities as described herein.

The method 300 may include, at block 302, executing computer-readable program code instructions of an AI productivity tool-enablable software application via a hardware processor, hardware controller or other hardware processing resource. As described herein, this AI productivity tool-enablable software application may be a service-mode application that operates in the background to provide services at the information handling system and may include AI productivity tool-enablable software applications such as a remediation (AMDS) software application, Dell® Optimizer® software application, Dell® Trusted Device® software application, Dell® Display and Peripheral Manager® software application, AWCC software application, Dell® Support Assist® software application, and the like. Additionally, some AI productivity tool-enablable software applications may include user-mode applications that the user may interface with such as Microsoft® Word®, Microsoft® Outlook®, and Microsoft® Excel® or others that may each utilize or include an AI productivity tool as part of the graphical user interface (GUI) that causes this type of AI productivity tool-enablable software application to invoke an ML model algorithm to facilitate the AI productivity capability associated with this AI productivity tool-enablable software application.

At block 304, the method 300 includes the AI productivity tool-enablable software applications registering the application capabilities and application information with the AI productivity tool subagent via execution of the computer-readable program code instructions of an application capabilities and telemetry gathering module. In an embodiment, this application information may include data or metadata that describes features of the AI productivity tool-enablable software application such as whether the AI productivity tool-enablable software application is a user-facing software application or a background-executing software application, an identification value that identifies the AI productivity tool-enablable software application, a description of the AI productivity tool-enablable software application in natural language, and capability intent values, among other data or metadata. These capabilities gathered by the application capabilities and telemetry gathering module may include data associated with the AI productivity tool-enablable software application such as application name or identifier, registerable capabilities, application information, user identification, application version, metadata or other designation whether the application is a service-mode application or a user-mode application, and the like. At this point, the AI productivity tool-enablable software application, at block 306, may be used to provide AI productivity features associated with the execution of the computer-readable program code instructions of the AI productivity tool-enablable software application.

An example of an AI productivity tool-enablable software application may include Dell® Display®/Peripheral Manager®. The Dell® Display®/Peripheral Manager® may be computer-readable program code instructions that have capabilities that include optimization of screen resolution, refresh rates, and gamma correction as well as webcam settings, mouse settings, keyboard settings, stylus settings, microphone settings, and trackpad settings, among other settings and connections associated with the wired or wireless input/output devices. Again, these capabilities associated with the execution of the Dell® Display®/Peripheral Manager® software application may be gathered with name, identification value, capability description in natural language or capability intent value by the application capabilities and telemetry gathering module. This is used, as described below, for prioritization of a first AI productivity tool-enablable software application invoking a first ML model algorithm relative to a second AI productivity tool-enablable software application invoking a second ML module algorithm.

It is appreciated that any AI productivity tool-enablable software application of computer-readable program code instructions in software, firmware, or some combination that may publish or provide a listing of capabilities including a capability name, capability identification value, capability description in natural language, or capability intent value to be gathered by the application capabilities and telemetry gathering module. For example, each AI productivity tool-enablable software application may publish or have assigned to it one or more descriptor terms or phrases for capabilities of the AI productivity tool-enablable software application for use with an AI productivity tool module, such as for a chatbot natural language system. Further examples of AI productivity tool-enablable software applications may include, for example, Dell® Trusted Device® application, a remediation Dell® APEX Managed Device Service (AMDS)® AI productivity tool-enablable software application, Alienware Command Center (AWCC)® AI productivity tool-enablable software application, among others. The capabilities of each of these AI productivity tool-enablable software applications, including a name, identification value, capability description in natural language or capability intent value with descriptors associated with those capabilities, may be gathered via execution, by the hardware processor or any other hardware processing device, of the application capabilities and telemetry gathering module. It is appreciated that each of these AI productivity tool-enablable software applications may also include their own AI productivity tool plug-in set of code instructions that interface with one or more AI productivity tool modules to receive input from the user and engage in AI productivity operations with specific AI productivity tool-enablable software applications as described herein.

At block 306, the method 300 includes the AI productivity tool-enablable software application may operate during normal usage until the user provides an input query (e.g., audio via a microphone or text via a keyboard for example) for the AI productivity tool-enablable software application that requires an ML model algorithm to process and embed the input query or an ML model algorithm to generate an AI generated responsive action. This will occur when the AI productivity tool module or the AI productivity tool-enablable software application requests an ML model algorithm to facilitate AI capabilities of the AI productivity tool-enablable software application. In an embodiment, the method 300 includes, at block 308, the hardware processor (e.g., CPU, NPU, EPU, EC, etc.) determining if the AI productivity tool or the AI productivity tool-enablable software application requires the ML model algorithm to be invoked and run. Where, for example, the AI productivity tool module or the AI productivity tool-enablable software application does not invoke an ML model, the method 300 returns back to block 306.

Where the hardware processor determines that the AI productivity tool module or the AI productivity tool-enablable software application requires an ML model algorithm, the method 300 proceeds to block 310 with the AI productivity tool-enablable software application initiating a request for the ML model algorithm by contract describing input and output requirements for the AI productivity tool or AI productivity tool-enablable software application needs of an ML model algorithm through an SDK. The SDK module may include any computer-readable program code instructions that is executed by the hardware processor to request that a machine learning model algorithm be provided during the execution of an AI productivity tool-enablable software application to support the contract for a determination of capabilities and executing those capabilities in response to a user input query. For example, where a user interacts with the GUI of an AI productivity tool-enablable software application being executed on the video display device that utilizes an AI productivity tool, the SDK module then requests, at block 312, from the AI productivity tool subagent a specific ML model algorithm that meets the requirements of the contract to be loaded and executed on a first hardware processing device of the information handling system. In a specific example, the user may be drafting a lengthy document or email and may select a speech-to-text AI productivity tool available within the word processing application (e.g., Microsoft® Word®) or email (e.g., Microsoft® Outlook®) application (e.g., both examples of an AI productivity tool-enablable software application). The selection of this speech-to-text AI productivity tool causes the AI productivity tool subagent to execute the SDK module in order to begin the process of communicating this request to a machine learning model requesting module for handling of that request. In an embodiment, the SDK module may present the request for the ML model algorithm such that a specific type of ML model algorithm that can meet the contract to perform the task of receiving speech audio input (e.g., via the microphone) and converting it to text for incorporation into the document or email of one of the AI productivity tool-enablable software applications being executed on the information handling system at the hardware processing device (e.g., CPU, EC 104, GPU 106, NPU, APU, etc.).

Also, at block 312, the SDK may inject the capabilities and application information into the call for the ML model algorithm. In some examples, user-specific information may be injected into the ML model algorithm executions as input to better facilitate the operation of the ML model and an AI productivity tool-enablable software application invoking that ML model. The application information may include user-specific or capability specific data that may be pre-sent with a request for invocation of the ML model algorithm to reduce a need for the execution of the ML model algorithm to request inputs or wait for inputs. For example, the capabilities and application information, in addition to application identification and descriptions of the application being a user-facing application or a background application, may include identification of the user of the information handling system. In a specific example, warranty information associated with the information handling system and user may be included with the capabilities and application information and may be used to determine whether, via execution of an ML model algorithm, a part within the information handling system is under warranty and therefor can be replaced without cost to the user. In this example embodiment, the user may have provided a query input asking whether and how a battery may be replaced. This warranty information may be used as input to provide specific output to the user describing warranty information about the battery. Through the execution of an ML model algorithm, therefore, the present method allows a user to determine if a battery issue is present at the information handling system, how to replace the battery, if the battery may be replaced by the user, and the like. In an embodiment, however, though some specialized data related to the capabilities or application information of the AI productivity tool-enablable software application invoking any ML model is provided with a request, other data may need to be monitored relating to effects of the invocation of the ML. This other data may be telemetry data gathered and monitored from sensors and software systems monitoring hardware components on the information handling system and execution of the ML model algorithms as described in embodiments herein.

At block 314, the AI productivity tool subagent may validate the request for the execution of the ML model algorithm. This validation process may include, for example, determining whether a specific ML model algorithm or a specific type of ML model algorithm that satisfies the request and contract of the AI productivity tool-enablable software application or AI productivity tool is available to the information handling system. In an example embodiment, the ML model algorithms available at the information handling system may be stored on a memory device (e.g., static memory such as a solid-state drive (SSD) or main memory) and accessible to the AI productivity tool subagent. In another example embodiment, the information handling system may be operatively coupled to a server on the network that maintains these ML model algorithms. In either of these examples, however, the certain ML model algorithm or type of ML model algorithm may not be available the AI productivity tool subagent. Thus, the validation process of the execution of the computer-readable program code instructions of the AI productivity tool subagent may initially determine the availability of these ML model algorithms and available location, if available, to match requests and contracts prior to proceeding.

Where, at block 316, it is determined that the request is not valid, the method 300 continues to block 318 with the AI productivity tool-enablable software application handling the error by, for example, informing the user that the system does not have access to the ML model algorithm and cannot process the request without a wired or wireless connection to a remote server where the ML model algorithms is available. At this point where the validation has failed, the method 300 may end.

Where at block 316, it is determined that the request for the ML model algorithm is valid, the method continues to block 320. The input by the user of the AI productivity tool within the AI productivity tool-enablable software application, therefore, sets off a process at block 320 by which a specific ML model algorithm is loaded to RAM if not already loaded or is maintained in RAM and then executed in order to provide to the user the ability to provide input via voice, text, or other input at the information handling system in order to receive AI generated output. At block 320, the AI productivity tool subagent may choose an ML model algorithm that can be used to service the request and satisfies the contract input, output, and other requirements for the AI productivity tool or the AI productivity tool-enablable software application capability. At this point, the SDK may receive, from the AI productivity tool subagent, an ML model algorithm handle and builds an AI productivity proxy API. The AI productivity tool-enablable software application beings to use the ML model algorithm for the AI productivity tool-enablable software application, at block 324, in order to submit inputs into and receive outputs from the execution of the ML model algorithm. This process includes the SDK injecting the capabilities and application information along with the ML model inputs to the ML model algorithm during use at block 326. This process may continue so long as the AI productivity tool-enablable software application requires the execution of the ML model algorithm.

At block 328, the method 300 includes executing computer-readable program code instructions of an ML model invocation effect monitoring module to track the effects of running the ML model algorithm on the information handling system. Execution of the computer-readable program code of the ML model invocation effect monitoring module may cause detected effects from the execution of the AI productivity tool-enablable software application invoking the ML model algorithm have on the operation of the information handling system as well as resource requirements associated with that execution. This telemetry data may include data associated with the invocation of the ML model algorithm and may include, in an embodiment, historical data describing how long a previous execution of SupportAssist® or other AI productivity tool-enable software application and its ML model algorithm has taken, the size of data required for input into the ML model algorithm invoked by the execution of the computer-readable program code of SupportAssist® or other AI productivity tool-enablable software application and its ML model algorithm, as well as the size of the data expected as output from the ML model algorithm, among other telemetry.

In an embodiment, this telemetry data may be gathered using any number of sensors or detectors that measure current operating telemetry data and operating conditions at the information handling system that may include CPU functions, RAM memory occupancy levels, power levels, solid state memory occupancy levels, and temperature levels, among other telemetry data. In a specific example, processor sensors or software, power sensors, or a temperature measuring device may be operatively coupled to hardware components such as a battery or the CPU to measure the processor utilization, power draw, or temperatures associated with those hardware devices. Still further, other computer-readable program code instructions of software modules may be executed to measure other telemetry data at other hardware devices. It can be appreciated that as the size of the input data and output data into and received out of the execution of the ML model algorithm increases the consumption of resources such a processing resources at the information handling system are increased thereby increasing the latency of operating the information handling system and the hardware processors (e.g., CPU, GPU, EC, APU, NPU, etc.) executing these and other software application and information handling systems.

As described herein, the telemetry data may be collected to determine conditions of the information handling system and the detected effect associated with the execution of any given ML model algorithm 266. An example of this telemetry data may include the level of processing resources consumed during the execution of an ML model algorithm under currently detected conditions of the information handling system. It is appreciated that an increase in consumption of processing resources at, for example a CPU, may be detected by processor sensors in hardware or software, power draw detecting sensor, or use of a temperature measuring device and provided to the ML model invocation effect monitoring module. Still further, it may also be appreciated that as increased amounts of hardware processing resources are used, power levels at a battery of the information handling system may be reduced and temperatures may increase at the battery. This measured telemetry data (e.g., as measured by the PMU and temperature measuring device) may also be transmitted to the ML model invocation effect monitoring module. The execution of the computer-readable program code of the OS and/or BIOS, in an example embodiment, may include processing speed, processor utilization levels or other processor function measurements that may also be detected telemetry data for a hardware processing resource and be provided to the ML model invocation effect monitoring module. Thus, in some embodiments, the execution of one or more ML model algorithms on behalf of one or more AI productivity tool-enablable software applications may affect the operation of the information handling system, and these effects of operation of the information handling system may be detected when the resulting telemetry data is provided to the ML model invocation effect monitoring module as described herein.

This data, in an embodiment, may be provided to the application capabilities and telemetry gathering module to determine if the execution of the computer-readable program code instructions of the AI productivity tool-enablable software application should be reprioritized relative to other AI productivity tool-enablable software applications and ML model algorithms being executed on the information handling system. For example, an AI productivity tool-enablable software application that utilizes a specific ML model algorithm above a threshold number of times or threshold period of time may be throttled so that other AI productivity tool-enablable software applications and ML model algorithms may operate. In a specific example, AI productivity tool-enablable software applications that are executed in a user-mode and service user interface actions directly may be prioritized over other AI productivity tool-enablable software applications invoking other ML model algorithms such that the user experience is not reduced by operation of other AI productivity tool-enablable software applications in the background. It is appreciated that any execution of the computer-readable program code instructions of any AI productivity tool-enablable software application and ML model algorithm may be either prioritized or deprioritized depending on, for example, certain settings associated with the operation of the information handling system. For example, where a user has selected a setting on the information handling system to prioritized conservation of battery power, those AI productivity tool-enablable software applications invoking certain ML model algorithms may be deprioritized where the execution of those AI productivity tool-enablable software applications and ML model algorithms increase processing resource consumption thereby requiring additional power from, for example, a battery of the information handling system.

At block 330, this data describing the effects of running the ML model algorithm on the information handling system by the AI productivity tool-enablable software application arc stored on an ML model effect database 332. Again, the telemetry data stored within the ML model effect database 332 may include a frequency of use of a ML model algorithm by any given AI productivity tool-enablable software application, the identification of AI productivity tool-enablable software applications and ML model algorithms, the identification of the user operating the information handling system and causing the execution of the AI productivity tool-enablable software application and the ML model algorithm, the amount of processing resources consumed during the execution of the ML model algorithm (e.g., CPU processing resource consumption), the amount of RAM occupied by the computer-readable program code instructions of the ML model algorithm, data input size for each ML model algorithm, and data output size for each ML model algorithm, among other data. Each of this telemetry data may be associated with execution of an identified a ML model algorithm and, in an embodiment, an AI productivity tool-enablable software application that invoked those ML model algorithms. In an embodiment, the ML model effect database 332 may be accessible to the application capabilities and telemetry gathering module as described herein in order to determine whether to prioritize or deprioritize the execution of any given AI productivity tool-enablable software application invoking any given ML model algorithm.

At block 334, the hardware processor or other hardware processing device of the information handling system may execute computer-readable program code of a ML model invocation effect monitoring module to determine if the AI productivity tool-enablable software application priority is to be changed based on the detected effects of executing the ML model algorithm invoked by AI productivity tool-enablable software application. As described herein, upon receiving user query inputs one or more of a plurality of ML model algorithms may be requested by one or more of a plurality of AI productivity tool-enablable software applications having a capability responsive to that user query input. As each of the AI productivity tool-enablable software applications invokes an ML model algorithm, the execution of the computer-readable program code of the ML model invocation effect monitoring module sorts among the executing ML model algorithms and helps to prioritize the execution of the ML model algorithms as described herein. In an embodiment, the detected telemetry and effects on the operation of the information handling system are received and, along with the user-defined or ITDM-defined policies, determines how to prioritize the execution of the ML model algorithms such that those policies are followed and triggered based on detected telemetry data of the current operating conditions of the information handling system. Where, for example, the execution of the AI productivity tool-enablable software application and ML model algorithm has adversely effected the operations or where it is determined that continued execution of the AI productivity tool-enablable software application invoking the ML model algorithm will adversely affect the operation of the information handling system, the method continues to block 336 with the hardware processor (e.g., CPU, GPU, APU, NPU, etc.) re-ranking the priority of the execution of the computer-readable program code instructions of the AI productivity tool-enablable software application.

At block 334, the hardware processing device may determine, for example, that the execution of the AI productivity tool-enablable software application invoking the ML model algorithm will consume at or above threshold level of the processing resources available at the information handling system based on the received telemetry data and the user-defined or ITDM-defined policies, the method 300 continues to block 336 as described so that the operation of the AI productivity tool-enablable software application invoking the ML model algorithm may be deprioritized under some example policies. However, at block 334 where the hardware processing device determines that the execution of the computer-readable program code instructions of the AI productivity tool-enablable software application invoking the ML model algorithm does not adversely affect the operation of the computer-readable program code instructions such that threshold processing resources are not reached, the method 300 includes maintaining the current priority of the AI productivity tool-enablable software application at block 338.

It is appreciated that various types of detected telemetry data and user-defined or ITDM-defined policies may be used during this process. As another specific example embodiment, the telemetry data may include RAM consumption metrics and the user-defined or ITDM-defined policies may define a threshold RAM consumption level at which the execution of the computer-readable program code of a given ML model algorithm should be prioritized or deprioritized. In this example embodiment, when the threshold RAM consumption level is reached, the execution of the ML model algorithm on behalf of an AI productivity tool-enablable software application may be deprioritized at block 338. Further, prioritization may be based on user mode execution of a capability of an AI productivity tool-enablable software application that is user-facing over background execution of capabilities. At this point, the method 300 may end with the decisions regarding whether to maintain a priority of the AI productivity tool-enablable software application or not.

The blocks of the flow diagram of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer readable code instructions of a first artificial intelligence (AI) productivity tool-enablable application invoking a machine learning (ML) on an information handling system comprising:
a hardware processor executing computer-readable program code instructions of an application capabilities and telemetry gathering module to receive registerable capabilities from a plurality of AI productivity tool-enablable software applications;
the hardware processor executing computer-readable program code instructions of a software development kit module to initiate a request, on behalf of the first AI productivity tool-enablable software application to an AI productivity tool subagent to invoke the ML model and instantiate the ML model algorithm to receive input from the first AI productivity tool-enablable software application;
the hardware processor executing computer-readable program code instructions of an ML model algorithm invocation effect monitoring module to gather telemetry data to monitor the effect of execution of the ML model algorithm invoked by the first AI productivity tool-enablable software application on the information handling system and store the telemetry data and the effect of the ML model algorithm invoked by the first AI productivity tool-enablable software application on a data storage device; and
the hardware processor executing computer-readable program code instructions of the application capabilities and telemetry gathering module to prioritize between the ML model algorithm invoked by the first AI productivity tool-enablable software application relative and a second ML model algorithm invoked by a second AI productivity tool-enablable software application based on an ML model execution system policy and the telemetry data for the effect of the ML model algorithm invoked by the first AI productivity tool-enablable software application.

2. The information handling system of claim 1 further comprising:
the hardware processor executing computer-readable program code instructions of a software development kit (SDK) module to transmit the registerable capabilities to the AI productivity tool subagent via a remote process communication (RPC).

3. The information handling system of claim 1, wherein the telemetry data for the effect of the ML model algorithm invoked by the first AI productivity tool-enablable software application includes data describing a frequency of use of the ML model algorithm, data describing hardware processor resource consumption via invocation of the ML model algorithm, data describing data storage consumption via invocation of the ML model algorithm, data describing data size of inputs to the ML model algorithm, or data describing data size of outputs from the ML model algorithm.

4. The information handling system of claim 1 further comprising:
the hardware processor to reprioritize invocation of the ML model algorithm for the first AI productivity tool-enablable software application within a priority list of ML model algorithm executions for the plurality of AI productivity tool-enablable software applications being executed on the information handling system based a change in the telemetry data currently detected for the effect on the information handling system of the ML model algorithm invoked by the first AI productivity tool-enablable software application.

5. The information handling system of claim 1 further comprising:
the telemetry data including stored historical data describing how long a previous execution of the ML model algorithm has taken, size of data required for previous input into the ML model algorithm invoked by the execution of the computer-readable program code of the first AI productivity tool-enablable software application, and the size of the data previously output from the ML model algorithm.

6. The information handling system of claim 1, wherein the registerable capabilities includes received application information from the first AI productivity tool-enablable software application include a name of a capability, a capability identification value, and a natural language description of the capability.

7. The information handling system of claim 1 further comprising:
the hardware processor to initiate a request, on behalf of the first AI productivity tool-enablable software application being executed on the information handling system, by the AI productivity tool subagent to load the ML model algorithm requested, and wherein the request includes application data received from the first AI productivity tool-enablable software application that is user specific usage data associated with the ML model algorithm invoked by the first AI productivity tool-enablable software application to be injected as initial input in the ML model algorithm to facilitate execution of the ML model algorithm without requiring a request for this user specific usage data.

8. A method of prioritizing execution of a machine learning (ML) model algorithms for artificial intelligence (AI) productivity tool-enablable applications on an information handling system comprising:
executing computer-readable program code instructions of an application capabilities and telemetry gathering module, via a hardware processor of the information handling system, to receive registerable capabilities from the AI productivity tool-enablable software applications executing on the information handling system;
executing computer-readable program code instructions, with the hardware processor, of a software development kit (SDK) module to initiate a request, on behalf of a first AI productivity tool-enablable software application, to an AI productivity tool subagent for the machine learning (ML) model algorithm to execute a capability;
executing computer-readable program code instructions, via the hardware processor, of the AI productivity tool subagent to receive the request from the first AI productivity tool-enablable software application to instantiate the ML model algorithm to receive input from the first AI productivity tool-enablable software application to the ML model algorithm; and
executing computer-readable program code instructions, via the hardware processor, of an application capabilities and telemetry gathering module to determine priority of execution of the ML model algorithm invoked by the first AI productivity tool-enablable software application relative to execution of a second ML model algorithm invoked by a second AI productivity tool-enablable software application based on an ML model execution system policy and telemetry data gathered relative to the execution of the ML model algorithm with the first AI productivity tool-enablable software application.

9. The method of claim 8 further comprising:
executing computer-readable program code instructions of a software development kit (SDK) module to transmit the registerable capabilities to the AI productivity tool subagent via a remote process communication (RPC).

10. The method of claim 8 further comprising:
executing computer-readable program code instructions of an ML model algorithm invocation effect monitoring module to monitor the effect of the ML model algorithm invoked by the first AI productivity tool-enablable software application on the information handling system from the telemetry data gathered, including operation level metrics of the hardware processor, and store the effect of the ML model algorithm invoked by the first AI productivity tool-enablable software application on a data storage device.

11. The method of claim 8, wherein the telemetry data gathered relating to execution of the ML model algorithm invoked by the first AI productivity tool-enablable software application includes data describing a frequency of use of the ML model algorithm, data describing hardware processor resource consumption via invocation of the ML model algorithm, data describing data storage consumption via invocation of the ML model algorithm, data describing data size of inputs to the ML model algorithm, or data describing data size of outputs from the ML model algorithm.

12. The method of claim 8 further comprising:
executing computer-readable program code instructions of the application capabilities and telemetry gathering module to reprioritize the ML model algorithm within a priority list of ML model algorithms being executed on the information handling system on behalf of the plurality of AI productivity tool-enablable software applications based on the effect on the information handling system of the ML model algorithm invoked by the first AI productivity tool-enablable software application and the current telemetry data measured, wherein the telemetry data includes hardware processor resource utilization.

13. The method of claim 8 wherein the telemetry data relating to execution of the ML model algorithm invoked by the first AI productivity tool-enablable software application includes historical data describing how long a previous execution of the ML model algorithm has taken, size of data required for previous input into the ML model algorithm invoked by the execution of the computer-readable program code of the first AI productivity tool-enablable software application, and the size of the data previously output from the ML model algorithm.

14. The method of claim 8, the telemetry data relating to execution of the ML model algorithm invoked by the first AI productivity tool-enablable software application includes tracked up-time of execution of the ML model algorithm by the first AI productivity tool-enablable software application.

15. The method of claim 8 further comprising:
initiating a request, on behalf of the first AI productivity tool-enablable software application being executed on the information handling system, by the AI productivity tool subagent to a machine learning model requesting module to load the requested ML model algorithm, wherein the request includes user specific usage data associated with the ML model algorithm invoked by the first AI productivity tool-enablable software application to be injected as initial input in the ML model algorithm to facilitate execution of the ML model algorithm.

16. An information handling system determining priority of execution of an ML model algorithm for an AI productivity tool-enablable software application comprising:
a hardware processor executing computer-readable program code instructions of an application capabilities and telemetry gathering module to receive registerable capabilities from the AI productivity tool-enablable software application;
the hardware processor executing computer-readable program code instructions of a software development kit module to initiate a request, on behalf of a first AI productivity tool-enablable software application of a plurality of AI productivity tool-enablable software applications being executed on the information handling system, to an AI productivity tool subagent for a first machine learning (ML) model algorithm to invoke the first ML model algorithm to receive input from the AI productivity tool-enablable software application to execute a capability; and
the hardware processor executing computer-readable program code instructions of the application capabilities and telemetry gathering module to determine a priority of the ML model algorithm invoked by the first AI productivity tool-enablable software application relative to a second ML model algorithm invoked by a second AI productivity tool-enablable software application based on an ML model execution system policy, telemetry data for the information handling system operation relating to execution of the ML model algorithm by the first AI productivity tool-enablable software application, and current telemetry data on operation of at least one hardware component of the information handling system.

17. The information handling system of claim 16 wherein the telemetry data for the information handling system operation relating to execution of the ML model algorithm by the first AI productivity tool-enablable software application includes data describing data describing data size of inputs to the ML model algorithm, or data describing data size of outputs from the ML model algorithm.

18. The information handling system of claim 16 further comprising:
the hardware processor executing computer-readable program code instructions of an ML model algorithm invocation effect monitoring module to monitor the telemetry data for operation of the at least one hardware component during execution of the ML model algorithm invoked by the first AI productivity tool-enablable software application on the information handling system and store the telemetry data on a data storage device, wherein the telemetry data includes data describing hardware processor resource consumption via invocation of the ML model algorithm, or data describing data storage consumption via invocation of the ML model algorithm.

19. The information handling system of claim 16, wherein the telemetry data for the information handling system operation relating to execution of the ML model algorithm by the first AI productivity tool-enablable software application includes a data describing a frequency of use of the ML model algorithm, or tracked up-time of execution of the ML model algorithm by the first AI productivity tool-enablable software application.

20. The information handling system of claim 16 further comprising:
the hardware processor to execute computer-readable program code instructions to reprioritize execution of the ML model algorithm of the AI productivity tool-enablable software application within a priority list of ML model algorithm executions for the plurality of AI productivity tool-enablable software applications being executed on the information handling system based on a change in the current telemetry data on operation of the at least one hardware component of the information handling system of invoking the ML model algorithm by the first AI productivity tool-enablable software application.
